(19) United States
(12) Patent Application Publication
(10) Pub. No.: US 2017/0369623 A1
(43) Pub. Date: Dec. 28, 2017

(54) WATER-SOLUBLE DIBLOCK COPOLYMER

(71) Applicant: ARKEMA FRANCE, Colombes (FR)

(72) Inventors: Raber INOUBLI, Pau (FR); Sylvain BOURRIGAUD, Morlanne (FR)

(73) Assignee: ARKEMA FRANCE, Colombes (FR)

(21) Appl. No.: 15/538,275

(22) PCT Filed: Dec. 14, 2015
(86) PCT No.: PCT/FR2015/053465

§ 371 Date: Jun. 21, 2017

(30) Foreign Application Priority Data
Dec. 23, 2014 (FR) 1463207

(51) Int. Cl. C08F 293/00; C08L 53/00; C08L 95/00

(52) U.S. Cl. CPC C08F 293/005; C08L 95/00; C08L 53/00; C08F 2438/02; C08L 2201/54

(57) ABSTRACT

The invention relates to the field of block copolymers, particularly to the field of water-soluble or water-dispersible copolymers consisting of two blocks, of which the major block is a hydrophilic thermoplastic block. More particularly, the invention relates to a block copolymer consisting of a partially or totally hydrophilic elastomeric block, with a Tg of less than 30° C. and comprising at least one hydrophilic monomer, and a water-soluble thermoplastic block with a Tg of greater than 30° C. and comprising at least one monomer bearing a carboxyl group, said copolymer being partially or totally soluble in water or in aqueous medium, and the mass proportion of the thermoplastic block being greater than 50% of the weight of said copolymer.

### FIELD OF THE INVENTION

The present invention relates to the field of block copolymers, particularly to the field of water-soluble or water-dispersible copolymers consisting of two blocks, of which the major block is a hydrophilic thermoplastic block. The invention also relates to processes for preparing said diblock copolymers by controlled radical polymerization. Finally, the invention is directed toward the various uses of these diblock copolymers as dispersants for pigments, or alternatively as rheology modifiers in applications as diverse as drilling muds, textile printing pastes, cosmetics, or alternatively detergency, and other coating compositions such as paint, and as antisedimentation agent and/or suspension agent for coarse mineral or organic fillers in various fields, for instance plant protection.

### TECHNICAL BACKGROUND

Block copolymers represent a class of compounds with noteworthy properties for a large number of applications.

The Applicant has already described in WO 2006/106 277 a linear ethylenic block copolymer comprising at least one first block A with a glass transition temperature of greater than 20° C., at least one second block B with a glass transition temperature of less than 15° C. and at least one third block C with a glass transition temperature of greater than 20° C., said first block A and third block C being identical or different and at least one of them comprising at least one monomer unit comprising at least one carboxyl and/or carboxylate function. Block B is predominant in said block copolymer, which leads to the use of said copolymer as an adhesive, especially a hot-melt adhesive.

In EP 1 525 283, the Applicant has described an adhesive composition for adhesion in wet medium, comprising as binder a block copolymer bearing at least one rigid hydrophilic block (B) constituting the minor phase dispersed in the form of nanodomains and at least one hydrophobic block (A) of elastomeric nature having a water-absorbing capacity of less than 20%, constituting the major continuous phase.

Other applications require, however, thermoplastic block copolymers that are able to be dissolved in water without having adhesive properties.

There is thus a need to prepare block copolymers simultaneously having a glass transition temperature (Tg) above room temperature and preferentially above 100° C., high mechanical strength, expressed, for example, in the form of an elastic modulus of greater than 10⁸ Pa at room temperature, which would be suitable for applications of the type such as dispersants or rheology modifiers mentioned above.

### SUMMARY OF THE INVENTION

The invention relates firstly to a diblock copolymer consisting of:
a partially or totally hydrophilic elastomeric block, with a Tg of less than 30° C. and comprising at least one hydrophilic monomer, and
a water-soluble thermoplastic block with a Tg of greater than 30° C. and comprising at least one monomer bearing a carboxyl group.

Characteristically, the mass proportion of the thermoplastic block is greater than 50%, preferably greater than or equal to 60% by weight of said copolymer. This give the block copolymer a thermoplastic nature.

According to one embodiment, the diblock copolymer according to the invention is extrudable and has thermoplastic polymer behavior at room temperature.

According to one embodiment, said diblock copolymer is granulable, having an elastic modulus G′ of greater than 10⁵ Pa at the cutting temperature. It is known to those skilled in the art that below a certain modulus level, it is difficult to granulate a polymer, including with cutting under water. This modulus limit might be linked to the values presented by the Dahlquist tack criterion, since, below this limit (10⁵ Pa), even using anticaking agents, it will not be possible to avoid caking problems.

Furthermore, said copolymer is partially or totally soluble in water or in aqueous medium. According to one embodiment, said copolymer is soluble in alkaline medium having a pH of greater than 8 and preferentially greater than 10.

Advantageously, the mass content of monomers bearing carboxyl functions in the diblock copolymer ranges from 10 to 40%, preferably from 20 to 35%, relative to the weight of said copolymer.

The invention also relates to a process for preparing said block copolymer by controlled radical polymerization.

Another subject of the invention is directed toward the various applications of the block copolymer according to the invention of the type such as: dispersants for pigments, or alternatively as rheology modifiers in applications as diverse as drilling muds, textile printing pastes, cosmetics, or alternatively detergency, and other coating compositions such as paint and as antisedimentation agent and/or suspension agent for coarse mineral or organic fillers in various fields, for instance plant protection.

### BRIEF DESCRIPTION OF THE FIGURES

FIG. 1 represents a diagram illustrating the solubility of the diblock copolymers according to the invention in aqueous medium, measured in terms of weight loss of the copolymer as a function of time.

FIG. 2 represents a diagram illustrating the variation of the elastic modulus G′ of a copolymer according to the invention, as a function of the temperature.

### DESCRIPTION OF EMBODIMENTS OF THE INVENTION

The invention is now described in greater detail and in nonlimiting manner in the description that follows.

According to a first aspect, the invention relates to a copolymer formed from a first elastomeric block and a second thermoplastic block.

The first block is an elastomeric block with a Tg of less than 30° C. and comprising at least one hydrophilic monomer. The term “monomer” means any monomer that is polymerizable or copolymerizable via a radical route. The term “monomer” covers mixtures of several monomers.

The term “Tg” denotes the glass transition temperature of a polymer, measured by DSC according to ASTM E1356. The term “Tg of a monomer” is also used, to denote the Tg of the homopolymer having a number-average molecular mass Mn of at least 10 000 g/mol, obtained by radical polymerization of said monomer.

Said hydrophilic monomer is advantageously chosen from:
acrylic acid or methacrylic acid,
hydroxyalkyl (meth)acrylates and (meth)acrylamides in which the alkyl group comprises 2 to 4 carbon atoms, in particular 2-hydroxyethyl methacrylate, 2-hydroxypropyl methacrylate, 4-hydroxybutyl methacrylate, dimethylacrylamide, N-(2-hydroxypropyl)(meth)acrylamide; polyethylene glycol or glycol acrylates and methacrylates optionally substituted on their terminal function with alkyl, phosphate, phosphonate or sulfonate groups.

The second block is a thermoplastic block with a Tg of greater than 30° C. It comprises at least one monomer bearing a carboxyl group. This monomer is preferably chosen from: acrylic acid, methacrylic acid, crotonic acid, itaconic acid, fumaric acid, maleic acid, citraconic acid, vinylbenzoic acid, the acrylamidoglycolic acid of formula CH₂═CH—CONHCH(OH)COOH, carboxylic anhydrides bearing a vinyl bond, and also salts thereof; and mixtures thereof. It is understood that, for the esters mentioned above, they will, after polymerization, be hydrolyzed to give units bearing —CO₂H functions.

By virtue of the hydrophilic monomer which comprises carboxyl functions that are capable of establishing hydrogen bonds with water molecules, the thermoplastic block is water-soluble or water-dispersible.

A polymer is said to be “water-soluble” if it is soluble in water (in other words, if it forms a clear solution) in a proportion of at least 5% by weight, at 25° C. Said thermoplastic block is especially soluble in running water or basic water.

A polymer is said to be “water-dispersible” if it forms, at a concentration of 5%, at 25° C., a stable suspension of fine, generally spherical, particles. The mean size of the particles constituting said dispersion is less than 1 μm, and more generally ranges between 5 and 400 nm, preferably from 10 to 250 nm. These particle sizes are measured by light scattering.

The hydrophilic thermoplastic block is rigid at room temperature and constitutes the major phase of the block copolymer according to the invention.

According to one embodiment, the diblock copolymer according to the invention has an elastic shear modulus G′ of greater than 10⁸ Pa at room temperature, which shows that, according to the Dahlquist tack criterion, it has no tacky nature.

According to a second aspect, the invention relates to a process for preparing the diblock copolymer described above. According to one embodiment, this diblock copolymer is obtained by controlled or living radical polymerization. Controlled radical polymerization makes it possible to reduce the reactions of the growing radical species, in particular the termination step, these being reactions which, in standard polymerization, irreversibly interrupt the growth of the polymer chain without control of the termination reactions. To solve this problem and to reduce the probability of termination reactions, it has been proposed to use “dormant” radical species, in the form of a bond with low dissociation energy, which are capable of blocking and restarting the polymerization as desired. Thus, depending on the need, periods of growth of the active radical species and periods of stoppage of growth are obtained. This alternation leads to an increase in the average molecular mass depending on the reaction progress, while at the same time control its execution. This control may be reflected by a narrower molecular mass distribution (lower polydispersity index) than in a standard radical route and also, and above all, may make it possible to synthesize block copolymers by restarting the polymerization with a new monomer using a “dormant” polymer species.

In principle, any living radical polymerization process which is compatible with the choice of the monomers may be used to prepare a block copolymer. A preferred method is controlled radical polymerization in the presence of a nitroxide mediator, since it makes it possible to polymerize a wide variety of monomers, especially acrylic monomers and acrylic monomers functionalized with carboxyl groups. To this end, use may be made, for example, of processes using as stable free radicals nitroxides such as SG1 or the alkoxyamine derivatives thereof as described in EP 0 970 973, WO 00/49027, WO 2005/082 945 and EP 1 527 079. A preferred controlled radical polymerization initiator is the alkoxyamine of formula (I) below:

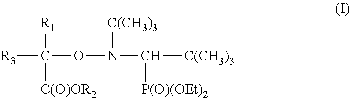

in which:
R₁ and R₃, which may be identical or different, represent a linear or branched alkyl group, containing a number of carbon atoms ranging from 1 to 3;
R₂ represents a hydrogen atom or, a linear or branched alkyl group containing a number of carbon atoms ranging from 1 to 8, a phenyl group, an alkali metal such as Li, Na, K, an ammonium ion such as NH4⁺, NHBu³⁺; preferably, R₁ and R₃ being CH₃ and R₂ being H, the abbreviation “Bu” meaning the butyl group.

An alkoxyamine that may be used to design the diblock copolymers of the invention, denoted by the name BlocBuilder®, corresponds to formula (II) below, in which the abbreviation “Et” means an ethyl group:

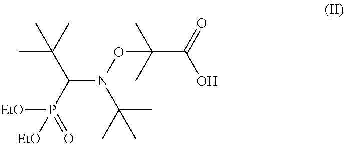 [SMILES: CCOP(=O)(OCC)C(N(OC(C)(C)C(=O)O)C(C)(C)C)C(C)(C)C]

The polymerization generally proceeds in several steps according to the following general scheme:
in a first step, polymerization of the first monomer or mixture of monomers comprising at least one hydrophilic monomer is performed to form a macroinitiator or precursor;
in a second step, polymerization of the second block constituted by a monomer or a mixture of monomers comprising at least one monomer bearing a carboxyl group, at the end of the macroinitiator, is performed.

The use of this process allows the synthesis of the diblock copolymers according to the invention in solution, in suspension, in bulk, in organic solvent or in emulsion, which then makes it possible to obtain the products in the form of an aqueous latex comprising a water-stable emulsion of these copolymers.

The organic solvent, when it is necessary for implementing a polymerization method, may be chosen from toluene, xylene, chloroform, ethyl acetate, methyl ethyl ketone, dioxane, tetrahydrofuran or dimethylformamide.

The process of the invention is generally performed at a pressure that may range from 0.5 to 20 bar and at a temperature that may range from 50 to 180° C., and preferably from 90 to 110° C.

The diblock copolymers obtained have controlled molecular masses and molecular mass distributions. Advantageously, the weight-average molecular mass M̅w̅ of the diblock copolymer is between 10 000 and 1 000 000 g/mol, preferably between 50 000 and 300 000 g/mol. The number-average molecular mass M̅n̅ is preferably between 10 000 and 50 000.

The molecular mass distribution or polydispersity index M̅w̅/M̅n̅ is generally less than 4, advantageously less than 2, and preferably less than or equal to 1.5. The masses M̅w̅ and M̅n̅ of the present invention are expressed as polyethylene glycol equivalents and measured by size exclusion chromatography, SEC, this technique also being known as GPC which stands for gel permeation chromatography.

The copolymers of the invention, which predominantly comprise water-soluble monomers, may especially be used as dispersants especially for pigments or mineral fillers in aqueous medium. They in particular make it possible to give good fluidity to aqueous dispersions of mineral particles, and more particularly to compositions based on hydraulic binders such as cement and plaster.

The diblock copolymers according to the invention may also serve as dispersants or co-stabilizers for emulsions of organic products, such as bitumen. They make it possible, in combination with standard surfactants, to make these emulsions more stable over time.

These copolymers may find their application in the formation of nanoporous films or alternatively as anti-soiling paint ingredient.

The invention also relates to filled and/or pigmented aqueous compositions containing the copolymer according to the invention. The filled and/or pigmented aqueous compositions are more particularly those which, besides the copolymer according to the invention, contain a mineral filler such as calcium carbonate, clays, iron oxides, sodium silico-aluminates or zeolites and/or one or more colorants and optionally a natural or synthetic binder and also optionally other constituents such as dispersants, coalescers, biocides, surfactants or antifoams.

Among all these aqueous compositions, containing the copolymer according to the invention, examples that may be mentioned include cosmetic compositions, textile printing pastes, aqueous suspensions of zeolites, drilling fluids, in particular water-based fluids, cream formulations for scouring, detergency formulations, paints and other coating compositions.

According to one embodiment, the elastomeric block contains butyl acrylate (BA) and methoxypolyethylene glycol methacrylate (MPEGMA) and the thermoplastic block contains butyl acrylate, methacrylic acid (MAA) and styrene (S) forming a P(BA-MPEGMA)-b-P(BA-S-MAA) diblock copolymer.

### EXAMPLES

The examples that follow illustrate the invention without limiting it.

### Example 1

### Synthesis of a P(BA-MPEGMA)-b-P(BA-S-MAA) Copolymer

The synthesis of this diblock copolymer takes place in two steps:

1^{st} block P(BA-MPEGMA) in bulk, followed by stripping of the unreacted monomers

2^{nd} block P(BA-S-MAA) in solvent

1.1. Synthesis of the Block P(BA-MPEGMA)

The synthesis of this first block is performed via a bulk polymerization process using a reactor of Ingénieur Büro type.

Reagents:

| | |
|---|---|
| butyl acrylate (BA) | 624 g |
| methoxypolyethylene glycol methacrylate (MPEGMA) | 126 g |
| BlocBuilder ® | 8.26 g |

A number-average molecular mass of 27 000 g/mol at 75% conversion is targeted.

The reagents are weighed out and then mixed with magnetic stirring, and are then introduced into the reactor by vacuum pressure. The reactor is stirred (250 rpm). The medium is degassed by alternating three cycles of nitrogen pressure and vacuum. The polymerization takes place in three temperature stages: 90° C. for 60 min, then 100° C. for 90 min, then 110° C. The polymerization time is 345 min. The conversion is monitored by dry extracts collected every hour from the samples. Since MPEGMA is not volatile, only the conversion of the butyl acrylate can be monitored by measuring the solids content (125° C. thermobalance and 125° C. vacuum oven).

When the targeted conversion is reached, the temperature is lowered to 80° C. Once the nominal temperature has been reached, the system is gradually placed under vacuum, and the unreacted monomers are distilled off (recovery in liquid nitrogen traps). The system is left for about 90 min at 80° C. and under maximum vacuum. When the distillation is complete, the nominal temperature is lowered to 40° C. Once this nominal temperature has been reached, 400 g of ethanol are introduced (by vacuum pressure) so as to dilute the medium. The system is left stirring for a few hours at 40° C. so as to thoroughly homogenize the solution. This solution is then recovered.

1.2. Synthesis of the block P(BA-S-MAA)

The synthesis is performed in the solvent process, using an ethanol/toluene mixture with a mass ratio of 60/40. The synthesis is performed with 45% of solvent relative to the total feedstock.

A 30/30/40 mass ratio BA/S/MAA mixture is introduced.

A P(BA-MPEGMA)-b-P(BA-S-MAA) copolymer with a mass composition of 30/70 with a 65% conversion of the 2^{nd} block is targeted.

The feedstock is prepared as indicated below:

1^{st} block diluted in ethanol: 200 g

BA/S/MAA: 104/104/138.7 (g)

ethanol/toluene: 138.4/161.2 (g)

The molar masses (PS equivalent) of this copolymer are as follows:

Mp=93 600 g/mom

Mn=55 100 g/mol

Mw=97 300 g/mom

Ip=1.77

### Example 2

### Measurement of the Solubility in Aqueous Medium of the Diblock Copolymer P(BA-MPEGMA)-b-P(BA-S-MAA)

For the solubility test, a pellet 20 mm in diameter and 1 mm thick is prepared with a press and at a temperature of 120° C.

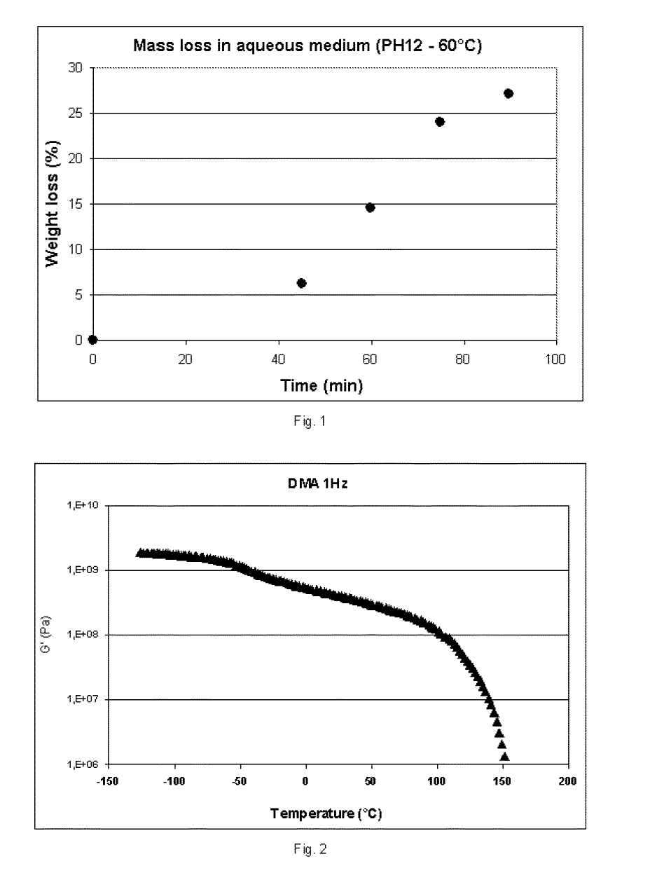

The pellet is placed in a gently stirred aqueous medium and mass loss measurements are taken as a function of time. The results obtained are represented in the attached FIG. 1.

Dissolution of the sample with a rate of mass loss of the order of 0.25% per minute is observed.

### Example 3

### Measurement of the Elastic Shear Modulus (G′) by Dynamic Mechanical Analysis (DMA) of the P(BA-MPEGMA)-b-P(BA-S-MAA) Diblock Copolymer

The elastic shear modulus is measured using an ARES strain-controlled rheometer (TA Instrument). A rectangular bar of dimensions 40×10×2 mm is prepared by molding. The analysis (temperature scanning at a frequency of 1 Hz) is performed on a geometry of rectangular torsion type.

The variations in modulus G′ as a function of temperature (from −80 to 150° C.) are presented in FIG. 2.

It is observed that, at room temperature, an elastic modulus G′ of about 4×10⁸ Pa is measured, which is evidence of behavior of thermoplastic type of the copolymer according to the invention.

1. A block copolymer comprising:
a partially or totally hydrophilic elastomeric block, wherein the elastomeric block has a Tg of less than 30° C. and comprises at least one hydrophilic monomer; and
a water-soluble thermoplastic block wherein the thermoplastic block has a Tg of greater than 30° C. and comprises at least one monomer bearing a carboxyl group;
wherein the block copolymer is partially or totally soluble in water or in aqueous medium, and the mass proportion of the thermoplastic block is greater than 50% of the weight of the block copolymer.

2. The block copolymer according to claim 1, wherein the hydrophilic monomer is selected from the group consisting of:
acrylic acid; methacrylic acid;
hydroxyalkyl (meth)acrylates in which the alkyl group comprises 2 to 4 carbon atoms; (meth)acrylamides in which the alkyl group comprises 2 to 4 carbon atoms; polyethylene glycol and glycol acrylates optionally substituted on their terminal function with alkyl, phosphate, phosphonate or sulfonate groups; polyethylene glycol and glycol methacrylates optionally substituted on their terminal function with alkyl, phosphate, phosphonate or sulfonate groups; and mixtures thereof.

3. The block copolymer according to claim 1, wherein the monomer bearing a carboxyl group is selected from the group consisting of: acrylic acid, methacrylic acid, crotonic acid, itaconic acid, fumaric acid, maleic acid, citraconic acid, vinylbenzoic acid, the acrylamidoglycolic acid of formula CH₂═CH—CONHCH(OH)COOH, carboxylic anhydrides bearing a vinyl bond, salts thereof, and mixtures thereof.

4. The block copolymer according to claim 1, wherein the mass content of monomers bearing carboxyl functions in the block copolymer ranges from 10 to 40%, relative to the weight of said copolymer.

5. The block copolymer according to claim 1, wherein the mass proportion of the thermoplastic block is greater than 60% of the weight of said copolymer.

6. The block copolymer according to claim 1, wherein the block copolymer is extrudable and granulable.

7. The block copolymer according to claim 1, wherein the block copolymer has an elastic shear modulus G′ of greater than 10⁸ Pa at room temperature.

8. The block copolymer according to claim 1, wherein the block copolymer has structure: P(BA-MPEGMA)-b-P(BA-S-MAA).

9. A process for preparing the block copolymer according to claim 1, wherein the process comprises carrying out controlled radical polymerization in the presence of a nitroxide mediator.

10. The process according to claim 9, wherein the controlled radical polymerization uses an alkoxyamine of formula II:

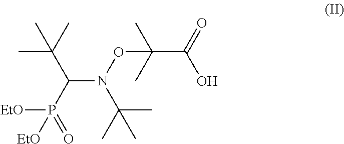 [SMILES: CCOP(=O)(OCC)C(N(OC(C)(C)C(=O)O)C(C)(C)C)C(C)(C)C]

11. The block copolymer according to claim 1, wherein the block copolymer is used as a dispersant for pigments or mineral fillers in aqueous medium.

12. The block copolymer according to claim 1, wherein the block copolymer is used as a dispersant or co-stabilizer for emulsions of organic products.

13. A filled aqueous composition comprising a block copolymer according to claim 1.

14. The composition according to claim 13, wherein the composition is used for cosmetics, textile printing pastes, aqueous suspensions of zeolites, drilling fluids, cream formulations for scouring, detergency formulations, paints and coatings.

15. The block copolymer according to claim 1, wherein the hydrophilic monomer is selected from the group consisting of: 2-hydroxyethyl methacrylate, 2-hydroxypropyl methacrylate, 4-hydroxybutyl methacrylate, dimethylacrylamide, and N-(2-hydroxypropyl)(meth)acrylamide, and mixtures thereof.

16. The block copolymer according to claim 2, wherein the monomer bearing a carboxyl group is selected from the group consisting of: acrylic acid, methacrylic acid, crotonic acid, itaconic acid, fumaric acid, maleic acid, citraconic acid, vinylbenzoic acid, the acrylamidoglycolic acid of formula CH₂═CH—CONHCH(OH)COOH, carboxylic anhydrides bearing a vinyl bond, and also salts thereof; and mixtures thereof.

17. The block copolymer according to claim 15, wherein the monomer bearing a carboxyl group is selected from the group consisting of: acrylic acid, methacrylic acid, crotonic acid, itaconic acid, fumaric acid, maleic acid, citraconic acid, vinylbenzoic acid, the acrylamidoglycolic acid of formula CH₂═CH—CONHCH(OH)COOH, carboxylic anhydrides bearing a vinyl bond, and also salts thereof; and mixtures thereof.

18. The filled aqueous composition comprising a block copolymer according to claim 13 wherein the filler is chosen from the group consisting of mineral fillers, calcium carbonate, clays, iron oxides, sodium silico-aluminates, zeolites, colorants, pigments, natural or synthetic binders, dispersants, coalescers, biocides, surfactants, antifoams, and mixtures thereof.

19. The block copolymer according to claim 12, wherein the organic product is bitumen.
